(19) United States
(12) Patent Application Publication
(10) Pub. No.: US 2018/0095569 A1
(43) Pub. Date: Apr. 5, 2018

(54) TOUCH DEVICE AND ELECTRONIC EQUIPMENT

(71) Applicants: BOE TECHNOLOGY GROUP CO., LTD., Beijing (CN); BEIJING BOE DISPLAY TECHNOLOGY CO., LTD., Beijing (CN)

(72) Inventors: Bin ZHANG, Beijing (CN); Qiang ZHANG, Beijing (CN); Guangxing WANG, Beijing (CN); Guomin LI, Beijing (CN)

(21) Appl. No.: 15/527,501

(22) PCT Filed: Nov. 8, 2016
(86) PCT No.: PCT/CN2016/104979

§ 371 Date: May 17, 2017

(30) Foreign Application Priority Data
Jan. 4, 2016 (CN) 201610003973.X

(51) Int. Cl. G06F 3/041

(52) U.S. Cl. CPC G06F 3/0412; G06F 3/044; G06F 2203/04112

(57) ABSTRACT

A touch device and an electronic equipment. The touch device includes a processing module, a plurality of first touch electrodes and a plurality of second touch electrodes; during an user carrying out a touch control operation, a target first touch electrode in the plurality of first touch electrodes forms a conductive link with a target second touch electrode in the plurality of second touch electrodes through skin of the user; and the processing module is configured to load a driving signal to the target first touch electrode, obtain a sensing signal from the target second touch electrode, and determine human body resistance of the user according to the variation of electrical parameters between the driving signal and the sensing signal. The touch device can determine the human body resistance of the user and reflect the health status of the user.

### TECHNICAL FIELD

Embodiments of the present disclosure relates to a touch device and an electronic equipment.

### BACKGROUND

With the development of the science and technology, electronic equipments with a touch panel have been widely popularized. Developing new functions based on the touch panel to bring more experience for an user is one of the developing directions of the current electronic equipment industry.

One of working principles of a current touch panel is: a processing module loads a driving signal to the screen through a touch driving electrode (also known as Tx electrode); when the skin of an user touches the screen, at the touch position electrical parameters of the loaded driving signal change so as to produce a sensing signal, the processing module obtains the sensing signal of the screen from a touch sensing electrode (also known as Rx electrode), thereby the touch position of the user can be determined and then the touch operation can be obtained.

### SUMMARY

Embodiments of the present disclosure provide a technical solution for determining human body resistance of an user based on the working principle of the touch screen, which can provide data support for judging health of the user.

An embodiment of the present disclosure provides a touch device, comprising a processing module, a plurality of first touch electrodes and a plurality of second touch electrodes; when an user presses the touch device, a target first touch electrode in the plurality of first touch electrodes forms a conductive link with a target second touch electrode in the plurality of second touch electrodes through skin of the user; and the processing module is configured to load a driving signal to the target first touch electrode, obtain a sensing signal from the target second touch electrode, and determine human body resistance of the user according to variation of electrical parameters between the driving signal and the sensing signal.

For instance, in the touch device, the processing module comprises a first determining unit configured to determine resistance between the target first touch electrode and the target second touch electrode according to a voltage value of the driving signal and electrical current value of the sensing signal; a second determining unit configured to determine the human body resistance of the user according to a formula:

$${R}_{f} = Z - j 2 π fL + \frac{2}{j 2 π {fC}_{f}} ;$$

wherein R_{f} is the human body resistance of the user; Z is the resistance between the target first touch electrode and the target second touch electrode; j is a constant; f is a frequency of the driving signal loaded by the processing module to the target first touch electrode; L is an inductance value of a connecting link between the processing module and the target first touch electrode; and C_{f} is a capacitance value of coupling capacitor formed between the skin and the target first touch electrode as well as the target second touch electrode during the user carrying out a touch operation.

For instance, in the touch device, the driving signal which the processing module is configured to load to the target first touch electrode is a variable frequency signal, the Z and the R_{f} are curvilinear functions; and the second determining unit takes the minimum value of the curvilinear function R_{f} as the human body resistance of the user.

In an embodiment of the present disclosure, the touch device can further comprise a first multiplexer, which is disposed on a link between the processing module and each first touch electrode and is configured to load the driving signal transmitted by the processing module to the target first touch electrode.

For instance, the touch device can further comprise an oscillator, which is disposed on a link between the processing module and the first multiplexer and is configured to carry out frequency conversion with respect to the driving signal transmitted by the processing module.

For instance, the touch device can further comprise a first operational amplifier circuit, which is disposed on a link between the oscillator and the first multiplexer and is configured to carry out power amplification with respect to the driving signal after frequency conversion.

For instance, the touch device can further comprise a second multiplexer, which is disposed on a link between the processing module and each second touch electrode and is configured to transmit the sensing signal on the target second touch electrode to the processing module.

For instance, the touch device can further comprise an I/V conversion circuit, which is disposed on a link between the second multiplexer and the processing module and is configure to carry out voltage conversion with respect to the sensing signal transmitted by the second multiplexer to the processing module.

For instance, the touch device can further comprise a second operational amplifier circuit, which is disposed on a link between the I/V conversion circuit and the processing module and is configured to carry out power amplification with respect to the sensing signal after voltage conversion.

For instance, the touch device can further comprise a filter circuit, which is disposed on a link between the second operational amplifier circuit and the processing module and is configured to carry out filtering with respect to the sensing signal after power amplification.

An embodiment of the present disclosure further provides an electronic equipment, comprising the above-mentioned touch device.

For instance, the electronic equipment can further comprise a determining module, which is configured to determine health information of the user according to the human body resistance of the user.

For instance, the electronic equipment can further comprise an alarming module, which is configured to alarm the health information to the user.

### BRIEF DESCRIPTION OF THE DRAWINGS

In order to clearly illustrate the technical solution of the embodiments of the disclosure, the drawings of the embodiments will be briefly described in the following; it is obvious that the described drawings are only related to some embodiments of the disclosure and thus are not limitative of the disclosure.

FIG. 1 is a schematic diagram of a user carrying out touch operation on a touch device of an embodiment of the present disclosure;

FIG. 2 is a working principle schematic diagram of a touch device of an embodiment of the present disclosure;

FIG. 3 is schematic diagram of a curvilinear relationship between a driving signal of an embodiment of the present disclosure and a human body resistance of the user when the driving signal is a variable frequency signal; and

FIG. 4 a structural schematic diagram of a touch device of an embodiment of the present disclosure.

### DETAILED DESCRIPTION

In order to make objects, technical details and advantages of the embodiments of the disclosure apparent, the technical solutions of the embodiments will be described in a clearly and fully understandable way in connection with the drawings related to the embodiments of the disclosure. Apparently, the described embodiments are just a part but not all of the embodiments of the disclosure. Based on the described embodiments herein, those skilled in the art can obtain other embodiment(s), without any inventive work, which should be within the scope of the disclosure.

Based on the working principle of the touch panel, an embodiment of the present disclosure provides a technical solution for further determining human body resistance (human skin resistance) of an user based on the variation of electrical parameters of a sensing signal and a driving signal while detecting the touch operation of the user, and the detected human body resistance can be used for further judging the health status of the user.

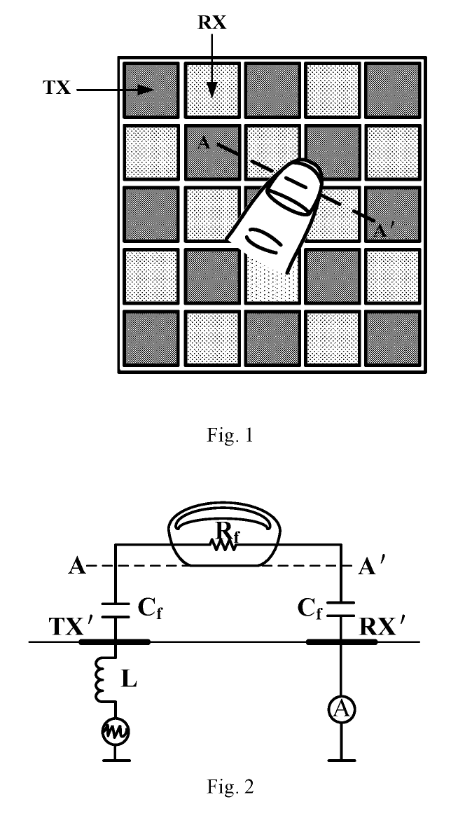

As illustrated in FIG. 1, an embodiment of the present disclosure provides a touch device, comprising: a processing module, a plurality of first touch electrodes and a plurality of second touch electrodes.

When an user presses the touch device, a target first touch electrode in the plurality of first touch electrodes forms a conductive link with a target second touch electrode in the plurality of second touch electrodes through the skin of the user; and the processing module is configured to load a driving signal to the above-mentioned target first touch electrode, obtain a sensing signal from the above-mentioned target second touch electrode, and determine the human body resistance of the user according to the variation of electrical parameters between the driving signal and the sensing signal.

The embodiment of the present disclosure uses the touch device to determine the human body resistance of the user through the variation of electrical parameters between the driving signal and the sensing signal, during the user pressing the touch device to carry out the touch operation and after forming of the conductive link between the target first touch electrode and the target second touch electrode through the skin of the user. Because the human body resistance can reflect the health status of the user, the touch device of the embodiment of the present disclosure has more practical values and practical scope.

The technical solution of an embodiment of the present disclosure to determine the human body resistance will be described in detail below.

For instance, with reference to FIG. 1 and FIG. 2, the touch device of the embodiment of the present disclosure comprises a plurality of driving electrodes TX and a plurality of sensing electrodes RX. For instance, when the user presses the touch device by a finger, the finger skin contacts with a target driving electrode TX′ in the driving electrodes TX and a target sensing electrode RX′ in the sensing electrodes RX to form a sensing circuit, with the help of the sensing circuit an electrical signal can be transmitted from the target driving electrode TX′ to the target sensing electrode RX′ through the finger skin, therefore the driving signal loaded by the processing module to the target driving electrode TX′ can be detected through the user finger as a sensing signal from the target sensing electrode RX′, and thus can be fed back to the processing module.

The principle of the processing module of an embodiment of the present disclosure to determine the human body resistance will be described in detail below.

For instance, the processing module of the embodiment of the present disclosure can further comprise a first determining unit, which is configured to determine resistance between the target first touch electrode and the target second touch electrode according to the voltage value of the driving signal loaded to the target driving electrode TX′ and the electrical current value of the sensing signal fed back from the target sensing electrode RX′.

As illustrated in FIG. 2, because the target driving electrode TX′ and the target sensing electrode RX′ form a series circuit through the human body carrying out touch, the resistance between the target first touch electrode (namely the target driving electrode TX′) and the target second touch electrode (namely the target sensing electrode RX′) can be obtained by the ratio of the voltage difference between the target driving electrode TX′ and the target sensing electrode RX′ to the electrical current value of the sensing signal.

For instance, the processing module of an embodiment of the present disclosure can further comprise a second determining unit, which is configured to determine the human body resistance of the user according to a formula:

$${R}_{f} = Z - j 2 π fL + \frac{2}{j 2 π {fC}_{f}} ;$$

in the above mentioned formula, R_{f} is the human body resistance of the user; Z is the resistance between the target first touch electrode and the target second touch electrode; f is the frequency of the driving signal loaded by the processing module to the target first touch electrode; L is inductance value of the connecting link between the processing module and the target first touch electrode; C_{f} is the capacitance value of coupling capacitances formed between the skin and the target first touch electrode as well as the target second touch electrode during the user carrying out a touch operation; j is a constant, under an ideal condition, the value of j is 1, and j can be adjusted in a proper range to calculate the error of the result. For instance, after the touch device is applied with a voltage, the internal circuit can achieve a stable operating temperature, and the operating temperature can generally lead to the effect that the actual value of the inductance L is larger than the theoretical value, therefore in the above mentioned formula, the value of j can be slightly larger than 1 to correct the inductance L, so as to calculate the human body resistance which is closer to the actual value.

Certainly, for instance, the driving signal of an embodiment of the present disclosure can be a variable frequency signal, correspondingly, the parameters Z and R_{f} in the above mentioned formula both are curvilinear functions, which are changed with the frequency of the driving signal. The more accurate human body resistance can be determined through the corresponding relationship between the human body resistance and the driving signals of different frequencies.

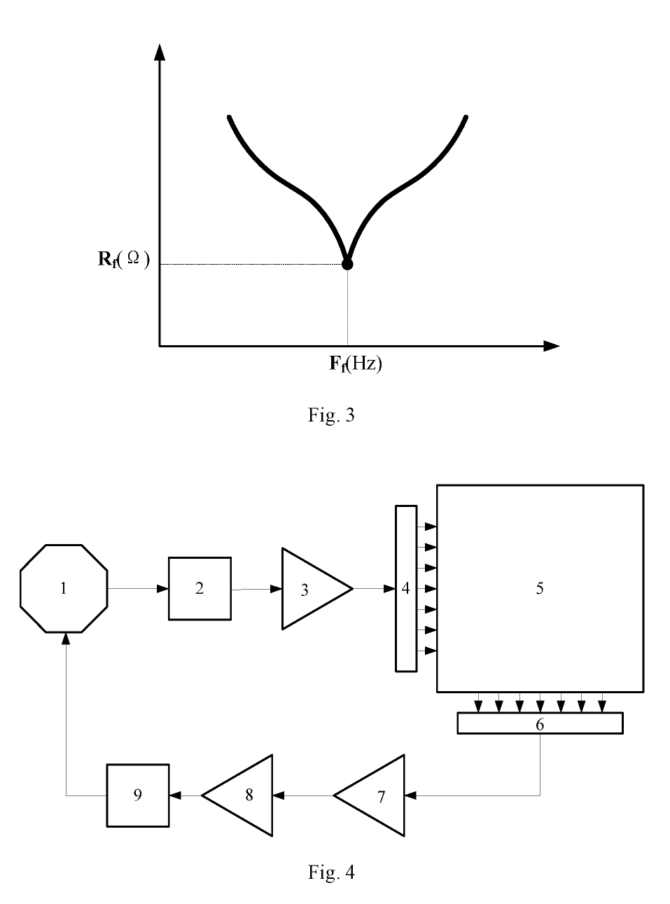

As an example, supposing that FIG. 3 is the corresponding curvilinear graph of the frequency f of the driving signal and the human body resistance R_{f}, when the frequency f of the driving signal changes in a certain range, the certain point (Fᵣ in FIG. 3) corresponds to the minimum value of the human body resistance, and the second determining unit of the embodiment of the present disclosure takes the minimum value of the curvilinear function R_{f} as the human body resistance of the user.

The structure of the processing module of an embodiment of the present disclosure will be described in detail below. The processing module of an embodiment of the present disclosure can be achieved through one or any combination of software, hardware and firmware, for instance, the processing module can comprise a processor such as a central processing unit (CPU), a digital signal processor (DSP) or other kind, and a memory such as a nonvolatile memory; a software program or instruction for performing an corresponding operation is stored in the memory, for instance, a software program for performing function of the first determining unit and the second determining unit.

Refer to FIG. 1 and FIG. 4, the touch device of the embodiment comprises a touch electrode layer 5, which comprises a plurality of first touch electrode and a plurality of second touch electrode.

For example, a first multiplexer 4 is disposed on a link between the processing module 1 and each first touch electrode. The first multiplexer 4 can be selected from any of existing devices or circuits for implementing multiple selection function, as a connecting component between the processing module 1 and each first touch electrode, which can selectively turn on the link of one or more first touch electrodes, so that the driving signal output from the processing module is transmitted to the target first touch electrode.

In addition, an oscillator 2 can be further disposed on a link between the processing module 1 and the first multiplexer 4, and the oscillator 2 is configured to carry out frequency variation with respect to the driving signal transmitted by the processing module.

In addition, a first operational amplifier circuit 3 can be further disposed on a link between the oscillator 2 and the first multiplexer 4, and the first operational amplifier circuit 3 is configured to carry out power amplification with respect to the driving signal after frequency variation.

On the other hand, the touch device of the embodiment can further comprise a second multiplexer 6, which is disposed on a link between the processing module and each second touch electrode of the touch electrode layer 5 and the same as the above mentioned first multiplexer 4, the second multiplexer 6 can be selected from any of existing devices or circuits with multiple selection function, as a connecting component between the processing module 1 and each second touch electrode, which can selectively turn on the link of one or more second touch electrodes, so that the sensing signal on the target second touch electrode is transmitted to the processing module.

An I/V conversion circuit 7 also can be disposed on a link between the second multiplexer 6 and the processing module 1, and the I/V conversion circuit 7 is configured to carry out voltage conversion with respect to the sensing signal transmitted by the second multiplexer 6 to the processing module 1, so as to obtain a voltage signal.

In addition, a second operational amplifier circuit 8 can be further disposed on a link between the I/V conversion circuit 7 and the processing module 1, and the second operational amplifier circuit 8 is configured to carry out power amplification with respect to the sensing signal after voltage conversion

In addition, a filter circuit 9 can be further disposed on a link between the second operational amplifier circuit 8 and the processing module 1, and the filter circuit 9 is configured to carry out filtering and noise reducing with respect to the sensing signal after power amplification, so that the processing module can obtain more accurate result. The touch device of the embodiment can further comprise an A/D conversion circuit or device for converting the sensing signal from an analog signal to an digital signal.

The touch device of an embodiment of the present disclosure can accurately determine the human body resistance of the user, and then provides the data support for judging the health status of the user.

In addition, another embodiment of the present disclosure further provides an electronic equipment (such as a mobile phone, a PAD, a smart wearable device, etc.), comprising the above mentioned touch device, which can determine the human body resistance of the user according to the touch operation of the user.

For instance, the electronic equipment of the embodiment of the present disclosure can further comprise a determining module, which is configured to determine health information of the user according to the human body resistance of the user. The determining module can be achieved through one or any combination of software, hardware and firmware.

As an example, the determining module of an embodiment of the present disclosure can be an application program of the electronic equipment, and converts the human body resistance to the corresponding health information based on the pre-set evaluation algorithm. Alternatively, the determining module of the embodiment of the present disclosure can further be an interactive device connected with a server, the pre-set evaluation algorithm is stored in the server, and the determining module can send a request to the server, so that the server can complete the evaluation of the health information of the user according to the evaluation algorithm. The above mentioned evaluation algorithm, for instance, can comprise establishing the relationship between the human body resistance and the health information based on the principle that the human body resistance is different in different health condition, and then achieving automatic search function according to the mapping relationship, so as to search the corresponding health information according to the human body resistance in the database, accordingly, after the determining module obtaining the human body resistance, the health information can be obtained according to the above mentioned algorithm.

In addition, the electronic equipment of an embodiment of the present disclosure can also comprise an alarming module, which is configured to alarm the health information to the user. The alarming module can be achieved through one or any combination of software, hardware and firmware.

As an example, the alarming module can alarm the determined health information of the user to the user through the mode of the screen displaying; or can send the health information to the e-mail address which the user pre-specified, so that the user can check his/her health status by mail; or send the health information to a predetermined APP.

In practical application, the user can turn on the function for detecting the human body resistance of the electronic equipment through an operation, in this case the screen of the electronic equipment can provide a virtual detecting area, the first touch electrode in the detecting area corresponds to the target first touch electrode, and the processing module only loads the driving signal to the target first touch electrode.

When the user places the finger on the detecting area, a detecting touch circuit is closed, and the processing module of the electronic equipment can receive the sensing signal from the target second touch electrode in the detecting touch circuit and load the driving signal to the target first touch electrode, so as to determine the human body resistance of the user.

In process of pressing on the detecting area by the user finger, there will be a maximum contact area of the finger surface at a certain moment, and the human body resistance determined by the processing module corresponds to the R_{f} in FIG. 3 at this time.

During determining of the human health information, the R_{f} can be compared with the normal value of the finger surface in a normal situation, furthermore the relevant diagnosis can be completed. Certainly, the user can input his/her corresponding finger surface to the electronic equipment in advance, so as to obtain more accurate final diagnosis result.

What are described above is related to the illustrative embodiments of the present disclosure only and not limitative to the scope of the disclosure; the scopes of the disclosure are defined by the accompanying claims.

The application claims priority to the Chinese patent application No. 201610003973.X, filed on Jan. 4, 2016, the entire disclosure of which is incorporated herein by reference as part of the present application.

1. A touch device, comprising: a processing module, a plurality of first touch electrodes and a plurality of second touch electrodes;
wherein during an user carrying out a touch control operation, a target first touch electrode in the plurality of first touch electrodes forms a conductive link with a target second touch electrode in the plurality of second touch electrodes through skin of the user; and
the processing module is configured to load a driving signal to the target first touch electrode, obtain a sensing signal from the target second touch electrode, and determine human body resistance of the user according to variation of electrical parameters between the driving signal and the sensing signal.

2. The touch device according to claim 1, wherein the processing module comprises:
a first determining sub-circuit configured to determine resistance between the target first touch electrode and the target second touch electrode according to a voltage value of the driving signal and an electrical current value of the sensing signal; and
a second determining sub-circuit configured to determine the human body resistance of the user according to a formula:
$${R}_{f} = Z - j 2 π fL + \frac{2}{j 2 π {fC}_{f}} ;$$
wherein R_{f} is the human body resistance of the user, Z is the resistance between the target first touch electrode and the target second touch electrode, j is a constant, f is a frequency of the driving signal loaded by the processing module to the target first touch electrode, L is an inductance value of a connecting link between the processing module and the target first touch electrode, and C_{f} is a capacitance value of a coupling capacitor formed between the skin and the target first touch electrode as well as the target second touch electrode during the user carrying out a touch operation.

3. The touch device according to claim 2, wherein,
the driving signal which the processing module is configured to load to the target first touch electrode is a variable frequency signal, Z and the R_{f} are curvilinear functions; and
the second determining sub-circuit is configured to take a minimum value of the curvilinear function R_{f} as the human body resistance of the user.

4. The touch device according to claim 1, further comprising:
a first multiplexer, which is disposed on a link between the processing module and each first touch electrode, and is configured to load the driving signal transmitted by the processing module to the target first touch electrode.

5. The touch device according to claim 4, further comprising:
an oscillator, which is disposed on a link between the processing module and the first multiplexer and is configured to carry out frequency conversion with respect to the driving signal transmitted by the processing module.

6. The touch device according to claim 5, further comprising:
a first operational amplifier circuit, which is disposed on a link between the oscillator and the first multiplexer and is configured to carry out power amplification with respect to the driving signal after frequency conversion.

7. The touch device according to claim 1, further comprising:
a second multiplexer, which is disposed on a link between the processing module and each second touch electrode and is configured to transmit the sensing signal on the target second touch electrode to the processing module.

8. The touch device according to claim 7, further comprising:
an I/V conversion circuit, which is disposed on a link between the second multiplexer and the processing module and is configure to carry out voltage conversion with respect to the sensing signal transmitted by the second multiplexer to the processing module.

9. The touch device according to claim 7, further comprising:
a second operational amplifier circuit, which is disposed on a link between the I/V conversion circuit and the processing module and is configured to carry out power amplification with respect to the sensing signal after voltage conversion.

10. The touch device according to claim 8, further comprising:
a filter circuit, which is disposed on a link between the second operational amplifier circuit and the processing module, and is configured to carry out filtering with respect to the sensing signal after power amplification.

11. An electronic equipment, comprising the touch device according to claim 1.

12. The electronic equipment according to claim 11, further comprising:
a determining module configured to determine health information of the user according to the human body resistance of the user.

13. The electronic equipment according to claim 12, further comprising:
an alarming module configured to alarm the health information to the user.

14. The touch device according to claim 2, further comprising:
a first multiplexer, which is disposed on a link between the processing module and each first touch electrode, and is configured to load the driving signal transmitted by the processing module to the target first touch electrode.

15. The touch device according to claim 14, further comprising:
an oscillator, which is disposed on a link between the processing module and the first multiplexer and is configured to carry out frequency conversion with respect to the driving signal transmitted by the processing module.

16. The touch device according to claim 15, further comprising:
a first operational amplifier circuit, which is disposed on a link between the oscillator and the first multiplexer and is configured to carry out power amplification with respect to the driving signal after frequency conversion.

17. The touch device according to claim 2, further comprising:
a second multiplexer, which is disposed on a link between the processing module and each second touch electrode and is configured to transmit the sensing signal on the target second touch electrode to the processing module.

18. The touch device according to claim 17, further comprising:
an I/V conversion circuit, which is disposed on a link between the second multiplexer and the processing module and is configure to carry out voltage conversion with respect to the sensing signal transmitted by the second multiplexer to the processing module.

19. The touch device according to claim 17, further comprising:
a second operational amplifier circuit, which is disposed on a link between the I/V conversion circuit and the processing module and is configured to carry out power amplification with respect to the sensing signal after voltage conversion.

20. The touch device according to claim 18, further comprising:
a filter circuit, which is disposed on a link between the second operational amplifier circuit and the processing module, and is configured to carry out filtering with respect to the sensing signal after power amplification.
